(19) United States
(12) Patent Application Publication
(10) Pub. No.: US 2002/0016735 A1
(43) Pub. Date: Feb. 7, 2002

(54) Electronic mail classified advertising system

(76) Inventors: Mark W. Runge, Colorado Springs, CO (US); John W. Street, Colorado Springs, CO (US); Mary M. Beazley, Colorado Springs, CO (US); Steven L. Parker, Colorado Springs, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/835,355

(22) Filed: Apr. 17, 2001

Related U.S. Application Data
(60) Provisional application No. 60/214,261, filed on Jun. 26, 2000.

(51) Int. Cl. G06F 17/60; G06F 15/16

(52) U.S. Cl. 705/14; 705/26; 709/203

(57) ABSTRACT

A system and method for establishing temporary electronic mail (e-mail) accounts is configured to operate with classified newspaper advertising. One of the aspects of the present invention is a file handling method that automates the process of establishing the e-mail accounts through interaction with a publisher's system for taking orders for classified advertisements. Typical newspaper classified advertising comprises two or three lines of text which provide only basic information about an item for sale. With the present invention, advertisers would be offered the option of creating a special e-mail account with a duration tied to the run of the advertisement. The e-mail accounts would be used to receive inquiries about the item for sale. The e-mail account could be also be configured to auto-respond to each incoming message with additional descriptive information about the item being offered for sale. Responders could learn more about the item, and thereby avoid the necessity of calling the seller. Sellers, in turn, can avoid the problem of repeated phone calls to request additional information, and may also remain anonymous while responding to multiple inquiries.

### CROSS-REFERENCE TO RELATED APPLICATION

This application claims the benefit of U.S. Provisional Application No. 60/214,261 filed Jun. 26, 2000.

### BACKGROUND OF THE INVENTION

1. Field of the Invention

The present invention generally relates to classified advertising and electronic mail (“e-mail” ) systems. More particularly, the present invention relates to a system for linking temporary e-mail accounts with classified advertisements to provide an enhanced classified advertising service to publishers and their advertisers and readers.

2. Related Art

The Internet is a computer network that connects millions of computers throughout the globe. The Internet is designed to be decentralized, so that each Internet computer (also called a “host” or server) is independent from all other computers connected to the network. A host's operators can choose which Internet services to use locally, and which local services to make available to the global Internet community. Remarkably, this anarchy by design works exceedingly well.

The World Wide Web (the “WWW” or “Web”) is a sub-set of Internet servers that support on-line “documents” formatted with special codes called markup languages (such as HyperText Markup Language or “HTML”). Such markup languages permit special computer applications called “Web browsers” to access Web documents and display them correctly for any Web user, regardless of that user's geographic location, server, computer, or operating system. Two of the most popular browsers are Netscape's Navigator and Microsoft's Internet Explorer. To view a particular Web document, the user's browser must electronically connect to the server that stores the file, and download a copy of the file to the user's computer. To accomplish this, each Web document has an electronic address represented in a Uniform Resource Locator (“URL”). A Web user can access, or “jump,”to a particular Web document by entering the document's URL in her browser's address field. For example, to view documents on the server of the Patent and Trademark Office, the user “points her browser” to the URL “www.uspto.gov” her browser then “jumps” to that address, and downloads and displays the document.

A Web document is commonly referred to as a “Web page,” and a Web user can jump from page to page using hypertext links (also called “hyperlinks” or just “links”). These links are shortcuts to other Web pages, whereby the URL of the other page is hidden by the markup language, and are typically underlined and highlighted in a different color (such as light blue). Instead of entering the URL of the other page (which can be quite long), the user merely clicks her mouse cursor on the hyperlink and her browser jumps to that Web page.

There are a variety of ways to access the Internet. Many on-line services exist, such as America Online, that offer access to some Internet services. It is also possible to gain access through a commercial Internet Service Provider (ISP). A typical function offered by these on-line services and ISPs is electronic mail (“e-mail”), which is the transmission of electronic messages over a computer network (such as the Internet) to an address (e.g., JSmith@usa.net). E-mail accounts inherently have and require unique addresses, otherwise the network would not be able to deliver the message to the appropriate account. E-mail typically contains text entered through the keyboard by the user, but can also have other computer files, photos, documents, and the like “attached” to the e-mail. E-mails can also contain hyperlinks that, when clicked, will launch the user's browser and jump to a Web page. Incoming messages are stored in electronic mailboxes until the recipient logs on to the e-mail account and reads them. E-mail programs exist as standalone computer applications, but e-mail functions also exist on Web pages, so a user need only have a browser and access to the Web to send and receive e-mail. A number of companies, including USA.NET of Colorado Springs, Colo., have developed systems for providing commercial and free web-based e-mail accounts for individuals and businesses.

The Internet has experienced explosive growth over the past few years, fueled largely by the growing popularity of the Web and e-mail. These two modes of communication and data exchange/retrieval are revolutionizing how people interact and conduct business. One business trade group has determined that e-mail has surpassed the telephone as the primary means of doing business. By recent estimates, the average American sends or receives 26.4 e-mail messages a day. Already there are over 200 million e-mail users in the world, and the community of Internet users worldwide is expected to swell from 97 million in 1998 to over 331 million in 2001. In fact, e-mail accounts for 91 percent of on-line activity, and by 2002 more than half of all men, women and children in the U.S. are expected to use e-mail regularly.

Two of the main attractions to e-mail and the World Wide Web is that communication is nearly instantaneous, and that a user can send or receive messages and information when it is convenient for that user. This is in contrast to, for example, telephone communication (which is instantaneous but disruptive for the call recipient) and traditional “snail” mail (which can be read when convenient for the recipient but is slow). Time zone differences, personal and family activities, and the desire for privacy (as well as other factors) combine to make telephonic communication intrusive, while a delay of several days makes “snail” mail untimely.

Despite e-mail's inherent advantage of permitting the user to read her mail when convenient, users are desiring ubiquitous access to their e-mail accounts. This is one of the benefits of Web-based e-mail: the user can access her messages from any computer with Internet access, anywhere in the world, and at any time. She need not be at her computer with her e-mail software. The manufacturers of electronic equipment are answering this demand by developing communication devices such as cellular telephones, pagers, and so-called Personal Digital Assistants (or “PDA”s, such as the PalmPilot) that can receive e-mail and access some features of the Internet.

One industry that can benefit from sophisticated e-mail systems is the classified advertising industry. Traditional classified advertisements include, along with the text of the ad that describes the item or service being advertised, a phone number that prospective buyers can call for additional information. However, it would be advantageous to have an alternate method for supplying such additional information other than by telephone. Many individuals find that e-mail messages are less disruptive and intrusive than phone calls. In addition, e-mail has the advantage of providing a written record that can be stored and retrieved at the user's convenience. Messages can be composed, edited, and sent without interrupting the activities of the recipient.

Additionally, both senders and recipients of e-mail can maintain confidentiality and privacy during the process. For example, anonymous e-mail accounts can be created through ISPs that do not disclose the name of the mail box owner. This can be a benefit to those sellers that wish to interact with potential buyers without publishing personal contact information.

A common commercial transaction for individuals is the buying and selling of articles through classified advertising in newspapers and other printed, on-line or video media. One of the difficulties of such transactions is that only a limited amount of information can be offered in the two or three lines of newspaper print that are typically allotted to such advertising. In addition, the per-word or per-line fee structure discourages a full printed description of the article for sale. For example, a typical advertisement for a used car might provide only the make, model, year, and general condition of the car. A potential buyer would likely be interested in the maintenance history, mileage, usage, and other characteristics that require lengthy description.

As a result of the limited amount of printed description, a seller can expect a stream of phone calls from strangers asking for further information and negotiation over the sale. This stream of calls could be considerably reduced if only there were a method for providing more specific information to potential buyers. In that case, many of the buyers would not have to disturb the seller to learn more about the article.

One potential way to deal with this situation is to provide additional information on a telephone answering machine. This has the drawback of tying up the seller's phone line. Invitations to inspect the article for sale have the drawback of requiring time and interactions with people who would not have otherwise been interested had more information been available to them in advance. E-mail provides a better medium for communications between buyers and sellers. Additional information can be exchanged (such as pictures, text, audio, or video), without requiring the disruption of personal phone calls or the time of personal inspections. However, many sellers may not have personal e-mail accounts, or may not want to publish publicly their personal e-mail addresses. A separate e-mail account that is associated with the classified ad would be desirable. Classified advertisement publishers, however, frequently do not want to become e-mail account providers. What is currently desired in the field of classified advertising, and what is addressed by the present invention, is a method and system for establishing temporary e-mail accounts tied to the duration of a classified advertisement, but which does not require the publisher to maintain an e-mail server or to significantly alter the way it sells classified advertising.

### SUMMARY OF THE INVENTION

The present invention is directed to a system and method for establishing temporary e-mail accounts configured to operate with classified advertising. Typical classified advertising comprises two or three lines of text, which provide only basic information about an item for sale. With the present invention, advertisers would be offered the option of creating a special e-mail account that would expire after some time related to the run-time of the advertisement. The e-mail account could be configured to auto-respond to inquiries with additional descriptive information about the item being offered for sale. Potential buyers could learn more about the item, and thereby avoid the necessity of telephoning the seller. Sellers, in turn, can avoid the problem of repeated phone calls to request additional information.

Buyers and sellers can also maintain confidentiality and privacy during the process of evaluating the item for sale. Potential buyers can obtain detailed information about the product through e-mail inquiries. Sellers can automatically provide additional information without having to publish personal phone numbers or personal e-mail accounts.

The system of the present invention also allows the seller to configure her classified ad e-mail account to forward received e-mails to a personal e-mail account, a pager, cell phone, PDA or fax.

Classified advertisement publishers can use the system of the present invention to offer this premium service to their classified advertisers. Because these publishers operate on rigid deadlines, they would prefer an automated sequence for establishing, operating, and purging e-mail accounts. The present invention provides a highly automated system to insure that e-mail accounts are created and ready for use at the time when the classified ads are published. Additionally, making the temporary e-mail accounts Web-based increases the convenience for sellers, and gives the publisher opportunities for increasing advertising revenues and improved Web presence. Other features and benefits of the present invention will become clear in the following detailed description of the invention and the attached drawings.

### BRIEF DESCRIPTION OF THE DRAWINGS

A more complete understanding of the present invention can be obtained by considering the following detailed description of the preferred embodiments thereof in conjunction with the accompanying drawings:

FIG. 1 is a schematic representation of the use of the classified advertising e-mail system according to the present invention.

FIG. 2 shows several examples of classified ads that include e-mail address contacts.

FIG. 3 illustrates a publisher's Web page with a hyperlink for accessing a classified ad e-mail account.

FIG. 4 illustrates a login page for accessing a classified ad e-mail account.

FIG. 5 illustrates a welcome page of a classified ad e-mail account.

FIG. 6 illustrates an inbox of a classified ad e-mail account.

FIG. 7 is an example of an auto-responder e-mail message according to the system of the present invention.

FIG. 8 illustrates a web page for formatting an auto-response message.

FIG. 9 is another example of an auto-responder e-mail message according to the system of the present invention, for real estate sales.

FIG. 10 is another example of an auto-responder e-mail message according to the system of the present invention, for employers.

FIG. 11 illustrates a web page for configuring the e-mail-forwarding feature of the present invention.

FIG. 12 is a schematic representation of the operation of the classified advertising e-mail system according to the present invention.

FIG. 13 is a schematic representation of the process of setting up an account with a classified e-mail service provider.

### DETAILED DESCRIPTION OF THE INVENTION

The system and method of the present invention enable publishers and publishing companies such as newspapers to offer their classified advertisers temporary e-mail addresses for use with each classified advertisement. Using a temporary e-mail address, rather than a personal e-mail address or phone number, gives the advertiser an interactive method of receiving responses without revealing personal information. Those responding to the advertisements can automatically receive additional information about the item for sale that is normally not possible in a typical classified ad. The temporary e-mail account can be configured by the advertiser to automatically respond with an e-mail containing detailed descriptions, photos, attached files, and so forth. Alternatively, the advertiser can choose to reply individually to each advertisement response. The system of the present invention permits publishers to offer this enhanced feature to its advertisers and readers without requiring the publisher to develop the expertise and expend the money to become an e-mail account provider. Alternatively, a publisher that has a Web page could choose to implement the present invention and host its own classified ad e-mail system, in order to enhance its on-line presence. A detailed description of the present invention follows, including the operation and use of the service, the method for setting up new publisher accounts, and details of the preferred embodiment of data file exchange.

Use of the Service

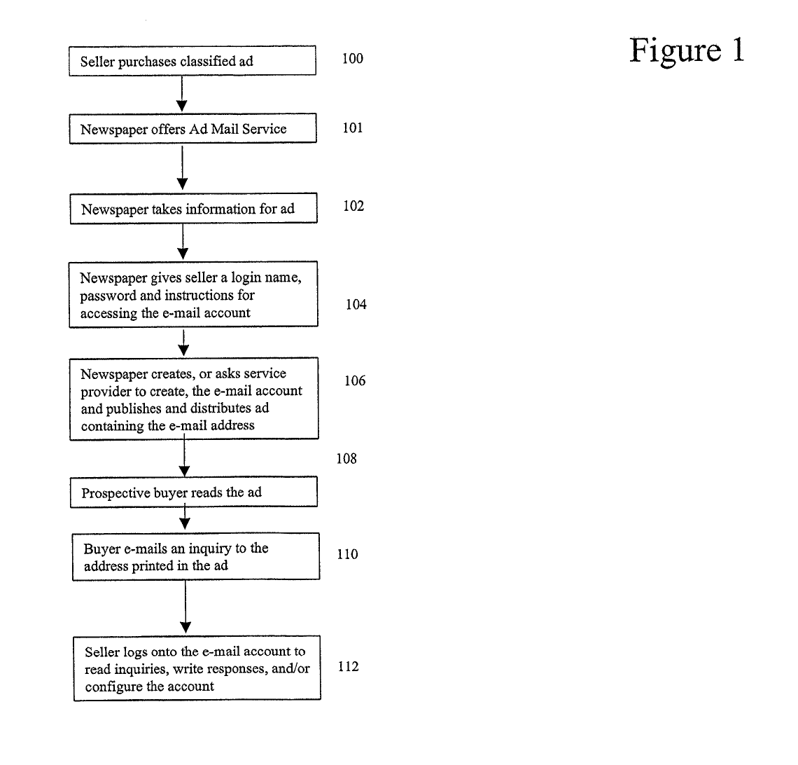

FIG. 1 illustrates how the service of the present invention is used by, for example, a person selling a car through newspaper classified ads. For clarity throughout this disclosure, the following terms and usage are defined. First, a “publisher” is any entity that publishes and/or distributes a classified ad. This includes the traditional newspaper publisher of classified ads, but the invention also covers magazine and other printed advertising, Web-based and other on-line classified advertising, and cable TV and other video classifieds. In the illustrative examples used below, the publisher of the classified ad will be referred to as a “newspaper.” The “advertiser” is the person purchasing the ad, and in the examples below will be referred to as the “seller.” Similarly, the person responding to the ad in the examples below will be referred to as the “buyer.” However, this terminology is not intended to limit the breadth of the disclosure. The present invention includes—and this disclosure is intended to cover—any of the well-known uses for classified advertising, including job openings; yard sales; real estate listings; lost and found announcements; “personals” listings; and so forth. In addition, the entity hosting the classified ad e-mail accounts, storing incoming messages, and hosting the management pages of the present invention is referred to as the “email service provider” or “service provider.” Finally, the invention is also directed to the arrangement where the newspaper hosts its own classified ad e-mail accounts and/or e-mail account login pages and management pages, instead of using a third-party service provider. In other words, the newspaper and the service provider can be the same entity.

At step 100 in FIG. 1, the seller purchases a classified ad from the newspaper. This purchase can be done over the phone, on-line, in person, through the mail, or through any other method of placing classified ads. As shown in step 101, a newspaper using the present invention can offer the seller, either as a premium or a standard feature, a temporary e-mail account for receiving inquiries about the car for sale. This e-mail account permits the seller to communicate with potential buyers without disclosing personal contact information. Moreover, because the e-mail account is accessible via the Web, the seller has easy access to her inquiries anywhere in the world, and can selectively reply to inquiries at any time, from anywhere. Other advantages and features of this e-mail account will be discussed below.

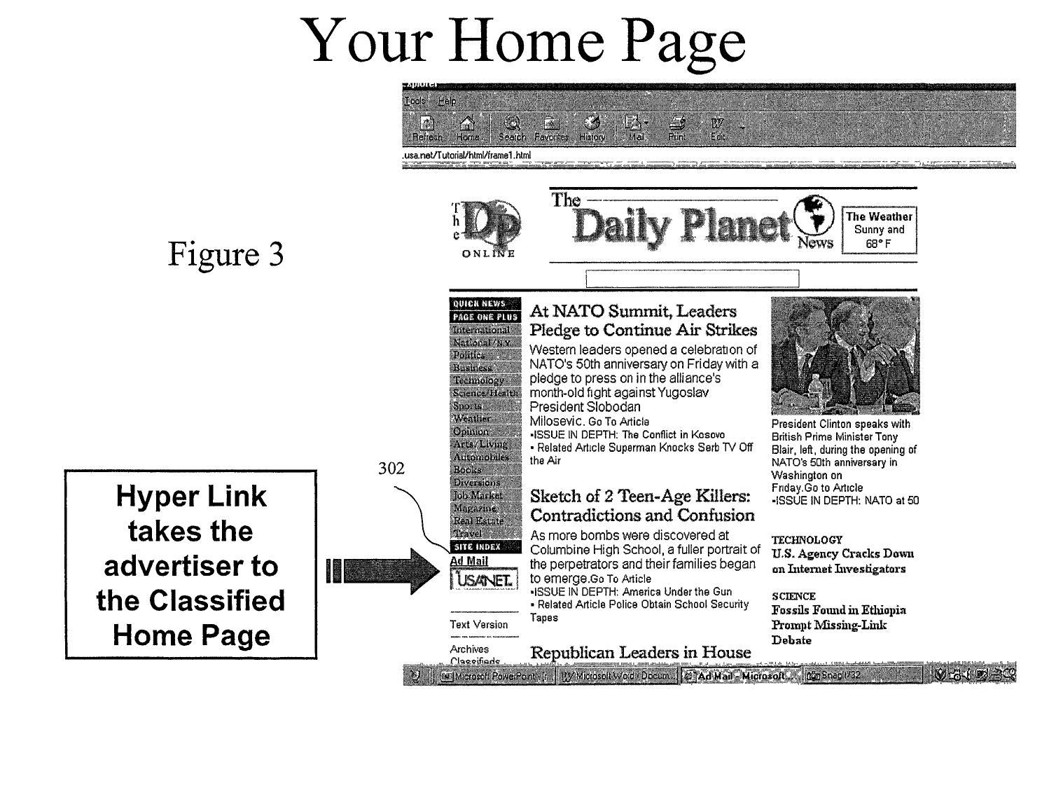

At step 102, the newspaper takes from the seller the information it needs for publishing the ad. For example, this information may include the text of the ad and the number of days the ad should be published, the seller's name, address, phone number, method of payment, and so forth. As explained below, this information (or a portion or subset thereof) will be used for creating the e-mail account associated with the classified ad. At step 104, the newspaper gives the seller the login name and password associated with the temporary e-mail account, and instructions for accessing the account on the Web. For example, the login name may be predetermined to be the seller's first initial and full last name (e.g., JSmith), or may be some randomly chosen number or character string. In the preferred embodiment, the login name (also known as the “userid”) is between 3 and 30 characters in length, and is case sensitive. In the preferred embodiment, the login name is the same as the mail field in the e-mail address (e.g., JSmith@dailyplanet.com). The password may also be a randomly chosen character string and, in the preferred embodiment, is a case-sensitive string between 5 and 29 characters in length. In alternative embodiments, the seller can select her own login name, password, or both. Accessing the e-mail account will be further explained below with respect to FIGS. 3 through 6.

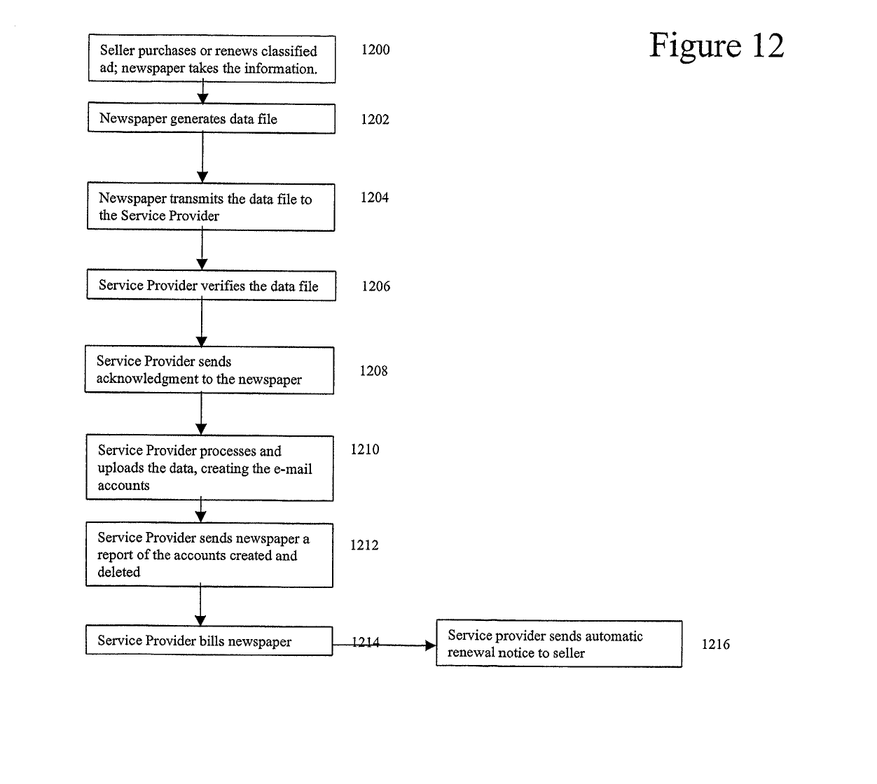

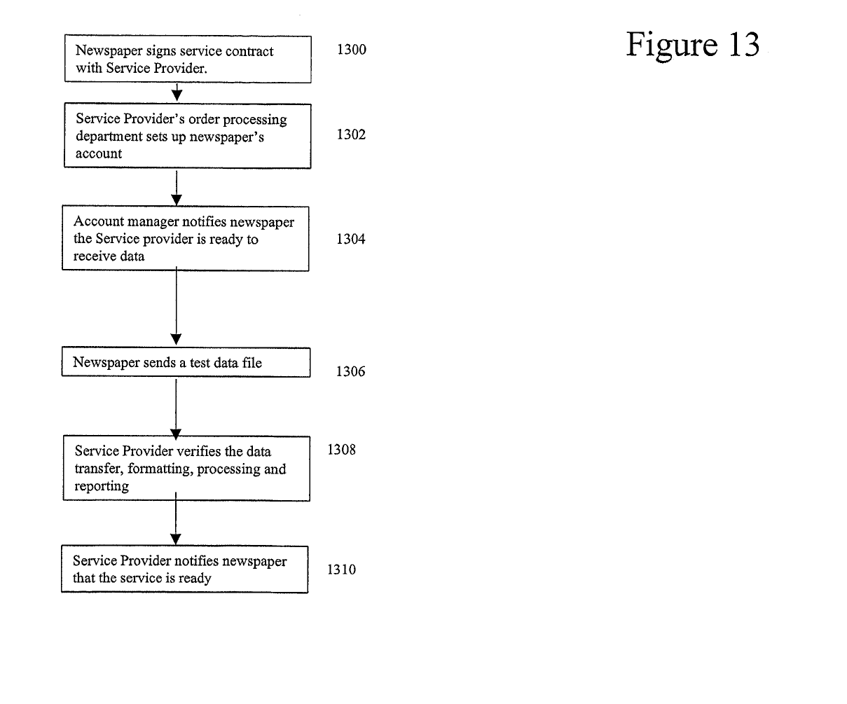

At step 106, the newspaper uses the information received from the seller, or a portion or subset thereof, for the creation of the e-mail account. As will be explained in more detail below with respect to FIGS. 12 and 13 and Tables 1 and 4, in a preferred embodiment the newspaper extracts from its classified ads sales database the information for the e-mail account, formats that information into a text file with comma-separated fields, and e-mails the file to the e-mail account service provider with a request to create the e-mail account. In the preferred embodiment, the text file is copied into the body of the e-mail, although other embodiments are possible (for example, including the text file as an attachment to the e-mail). In an alternative embodiment also to be explained below, the service provider may provide a Lightweight Directory Access Protocol (LDAP) interface that will allow the newspapers to develop custom applications to access the service provider's master service directory and, thus, create e-mail accounts directly on the service provider's system. Those skilled in the art will recognize that other interface embodiments are possible, such as XML, CGI, and so forth. In either of these preferred embodiments, the newspaper offloads the e-mail functions onto the service provider, so that the newspaper does not have to host an e-mail system. In a third embodiment, however, the newspaper can host and run the e-mail system on its own server, and the newspaper extracts the advertisement data to create accounts on its own system. The IP address represented by the newspaper's domain name can differ depending on whether the domain name is part of a URL or an e-mail address, as is understood by one skilled in the art. This is done so that the newspaper can host its own Web page, but the service provider can host the classified ad e-mail system. Someone surfing the Web will be directed to the newspaper's Web site, while an e-mail addressed to one of the newspaper's classified e-mail accounts will be directed to the service provider's e-mail server.

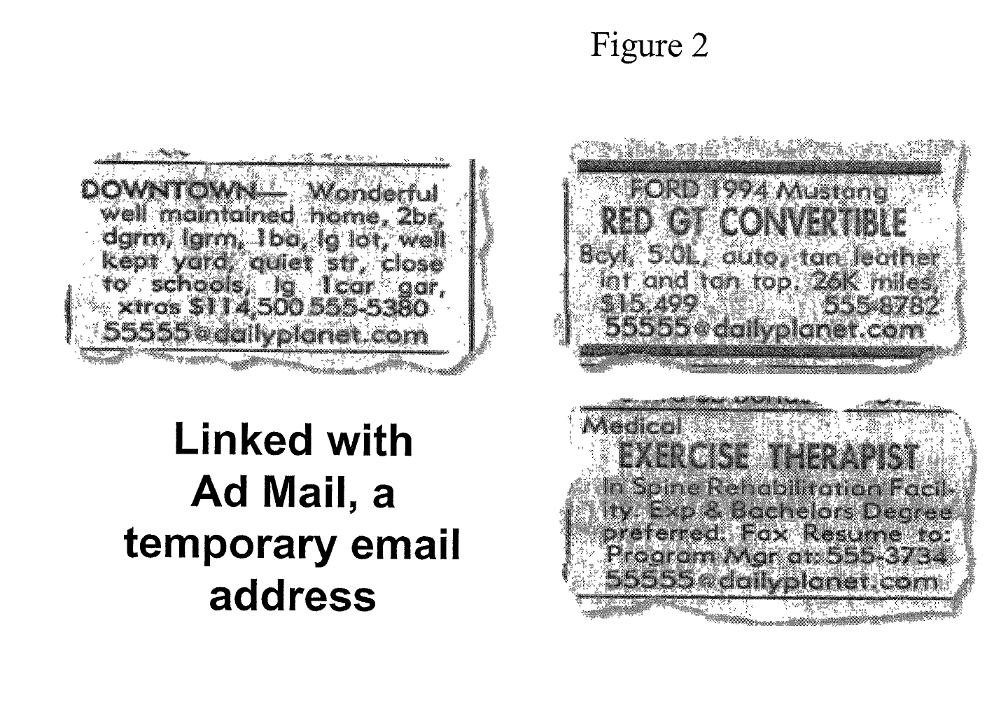

Also as indicated in 106, the newspaper of course publishes and distributes the advertisement, and includes or incorporates the address of the temporary e-mail account in the text of the advertisement. FIG. 2 illustrates examples of classified ads with associated e-mail addresses. As mentioned above, the distribution of the ad may be on-line or through printed or video publication.

At step 108, the prospective buyer peruses the classified ads and reads the seller's ad. Again, the buyer could be reading the newspaper or other printed article, “surfing” the newspaper's classified ads Web page, using an on-line classifieds search engine, or viewing video classifieds on, for example, a cable TV classified ads channel. The invention—and this disclosure—is not limited by the channel by which the classified ad is distributed. At step 110, interested buyers e-mail the address printed in the ad. The buyers can ask questions about the car, ask for additional details, accept the offer or propose a counteroffer, or perform a myriad of other actions with respect to the car for sale.

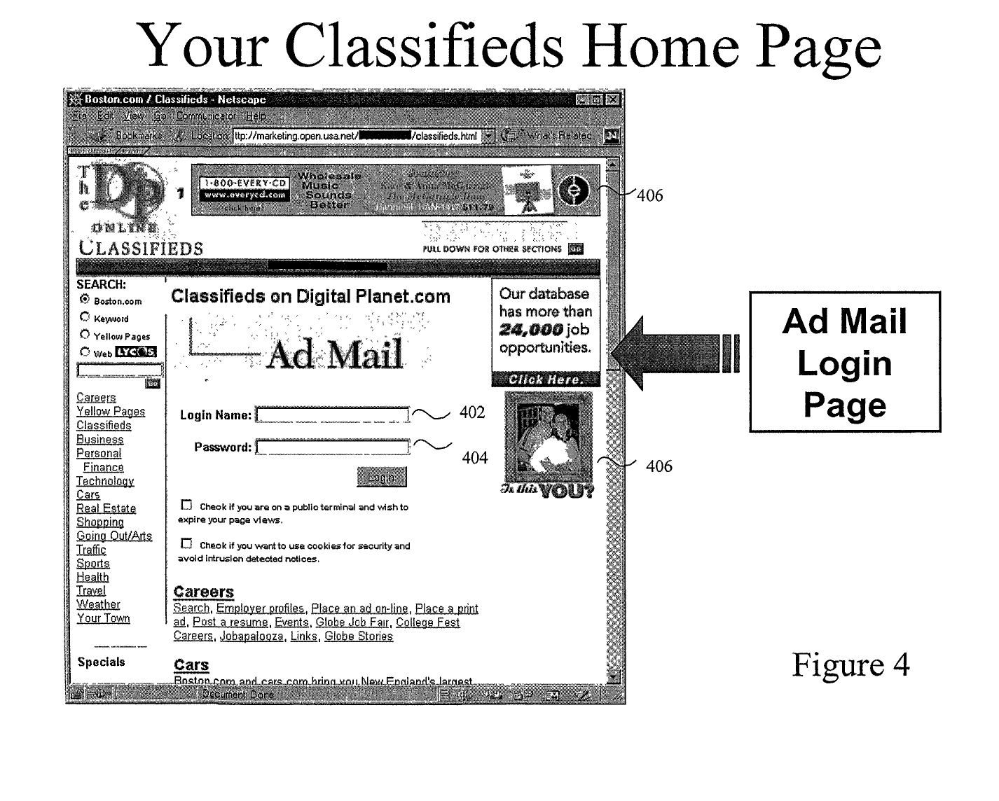

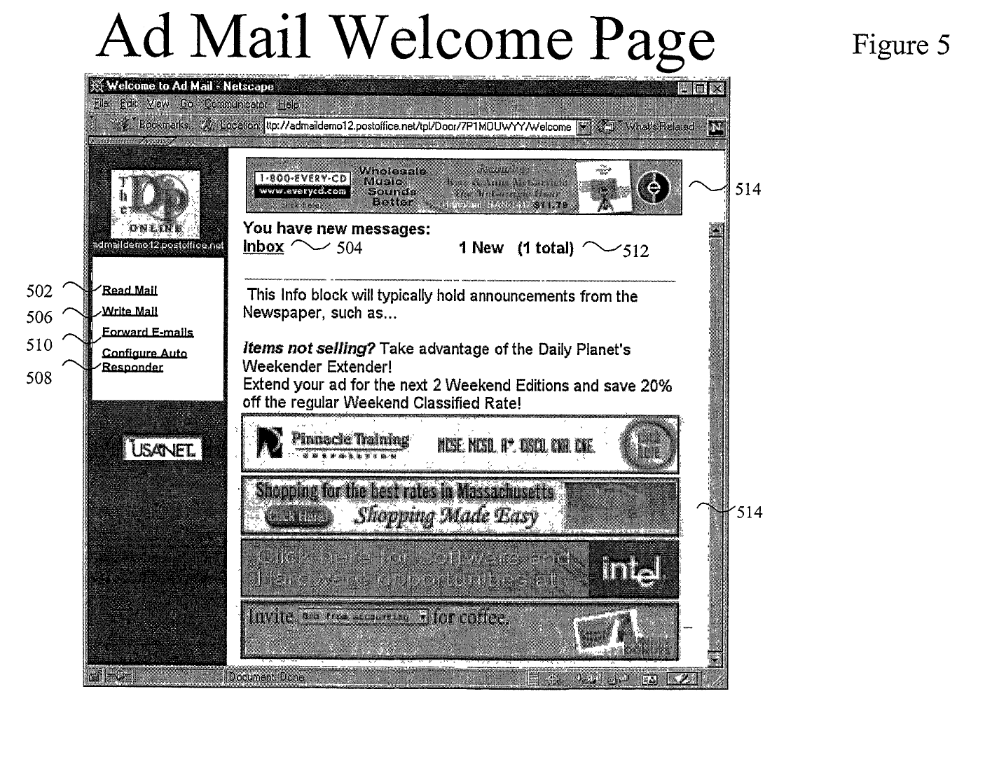

At step 112, any time after the e-mail account is created, the seller can log onto the e-mail account to read inquiries, write responses, and configure other features of the account. FIGS. 3 through 6 illustrate, in the preferred embodiment, the process of logging on to the seller's temporary e-mail account. First, the seller logs onto the newspaper's Web page, illustrated in FIG. 3, by pointing her Internet browser to the newspaper's URL, as is well known in the art. Typically, the Web page will have a hyperlink 302 (or a series of hyperlinks) that, when clicked, will cause the seller's browser to jump to the Ad Mail login page, FIG. 4. Alternatively, the seller could point her browser directly to the Ad Mail login page, by entering the login page's URL, if known. If the newspaper does not have its own Web page, the service provider can provide or “host” the newspaper's Ad Mail login page. At the login page in FIG. 4, the seller enters her login name in the Login Name field 402 and her password in the Password field 404. These are the login name and password that she received when she purchased the ad. If the Login Name and password match, the system causes the seller's browser to jump to the Ad Mail welcome page, FIG. 5. In the preferred embodiment, this jump to the Ad Mail welcome page is also a jump from the newspaper-hosted Web page to the service provider-hosted e-mail account pages or, content from the service provider is provided to the user via the newspaper's Web site. In other words, the newspaper's Web page and login page reside on the newspaper's server, while the welcome page and all e-mail account pages described hereafter reside on the service provider's server. In an alternative embodiment, the entire classified e-mail system can be hosted and run by the newspaper on its own website. From the welcome page, the seller can follow various hyperlinks to manage and use her e-mail account, including reading received messages 502 or 504; writing e-mails 506; setting up an “auto-response” 508 (explained in detail below); or forwarding received e-mails to another account 510 (also explained in detail below).

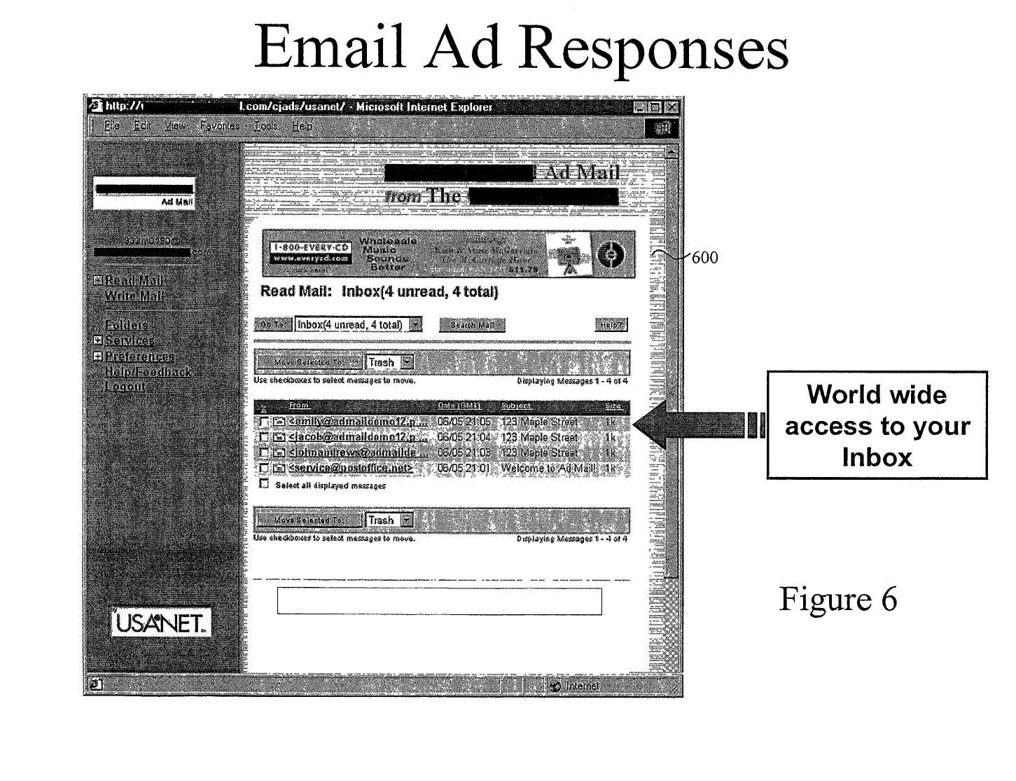

Clicking on the Read Mail link 502 or the Inbox link 504 will take the seller to the Read Mail screen illustrated in FIG. 6. Here, the seller can read e-mails, reply to e-mails, move e-mails to selected folders, delete e-mails, and perform other functions to use and manage her received e-mails using techniques that are well known in the art. While the seller is reading a given e-mail, she can write the prospective buyer by using the “reply” function that is well known in the art, and composing her message. The seller can respond to questions, propose a time to meet the buyer, accept offers or counteroffers, propose offers or counteroffer, and so forth. Alternatively, the seller can jump straight to e-mail composition by clicking on the Write Mail link 506 illustrated in FIG. 5. The Welcome Page also shows the seller how many new e-mails she received and how many total e-mails are in her inbox 512.

The e-mail inbox illustrated in FIG. 6 can also reduce administrative hassles and assist the seller in managing sales. In effect, the e-mail account becomes a temporary filing system for a particular listing. For example, it can be used to sort, track and quantify real estate contacts; or it can be used to identify new customers based on interest in specific vehicles; or it can be used to develop mailing lists for future follow-up and special offers.

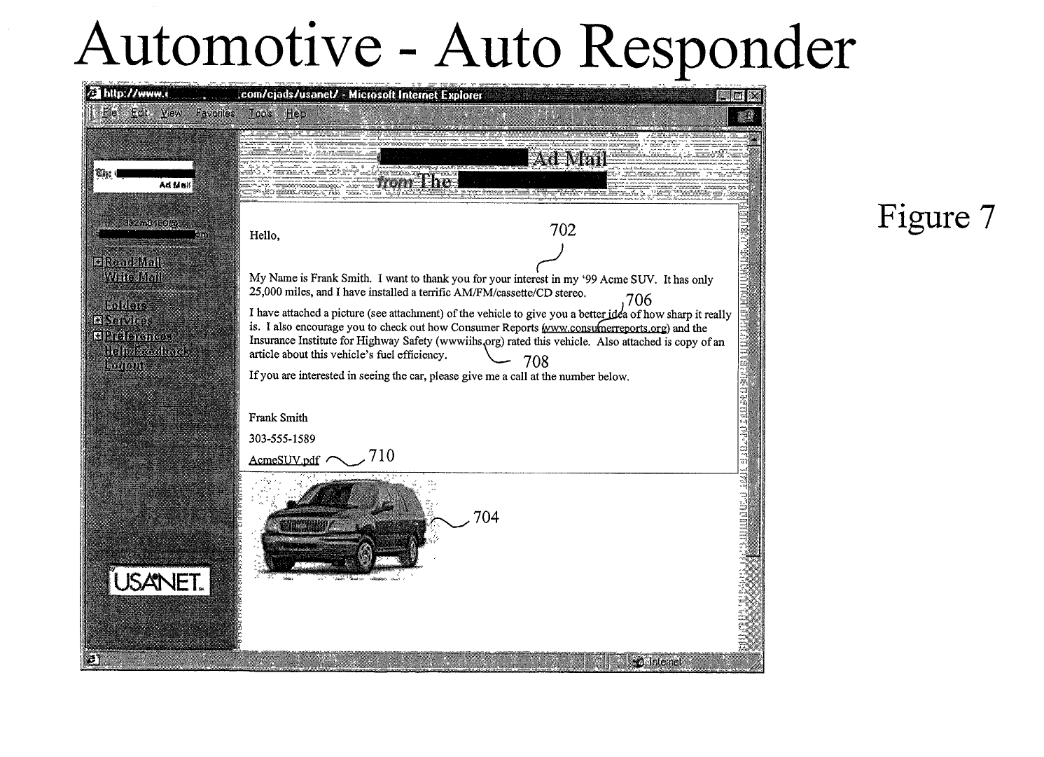

In many instances, the seller will not want to compose individual responses to every received inquiry. Instead, the seller can configure an “auto-response” feature of her account to reply automatically to every received e-mail, or to some selected few. The seller can enable and configure this feature by clicking on the “Configure Auto-response” hyperlink 508 illustrated in FIG. 5. An auto-response comprises a return e-mail containing additional information about the car for sale. FIG. 7 illustrates an auto-response and possible items that can be included. For example, the auto-response can include additional detailed information 702 about the car such as mileage, condition, service history, upgrades and so forth; photos 704 of the car or a map to the dealership; hyperlinks 706 and 708 to relevant Web pages; and attached forms, letters or other documents 710. The information in the auto-response can be updated at any time to reflect changes in, for example, the seller's asking price. The goal of the auto-response is to give a potential buyer additional information about the car, thus generating further interest by the prospective buyers. It is also a timesaving tool for the seller that reduces the need to compose individual responses to inquiries.

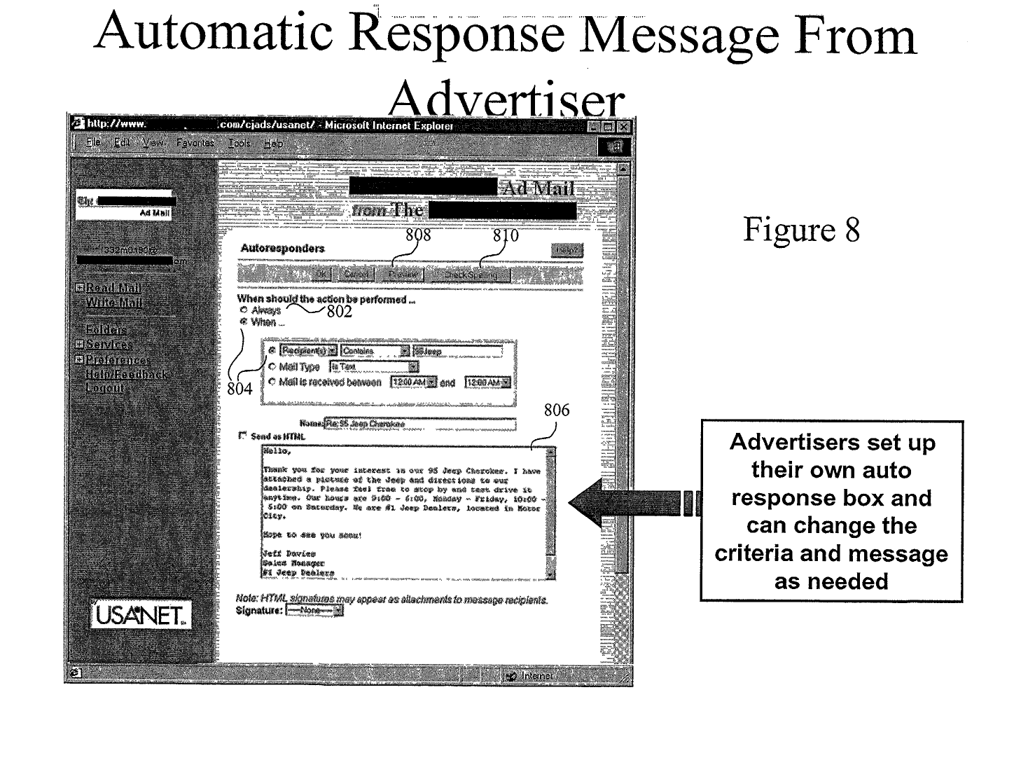

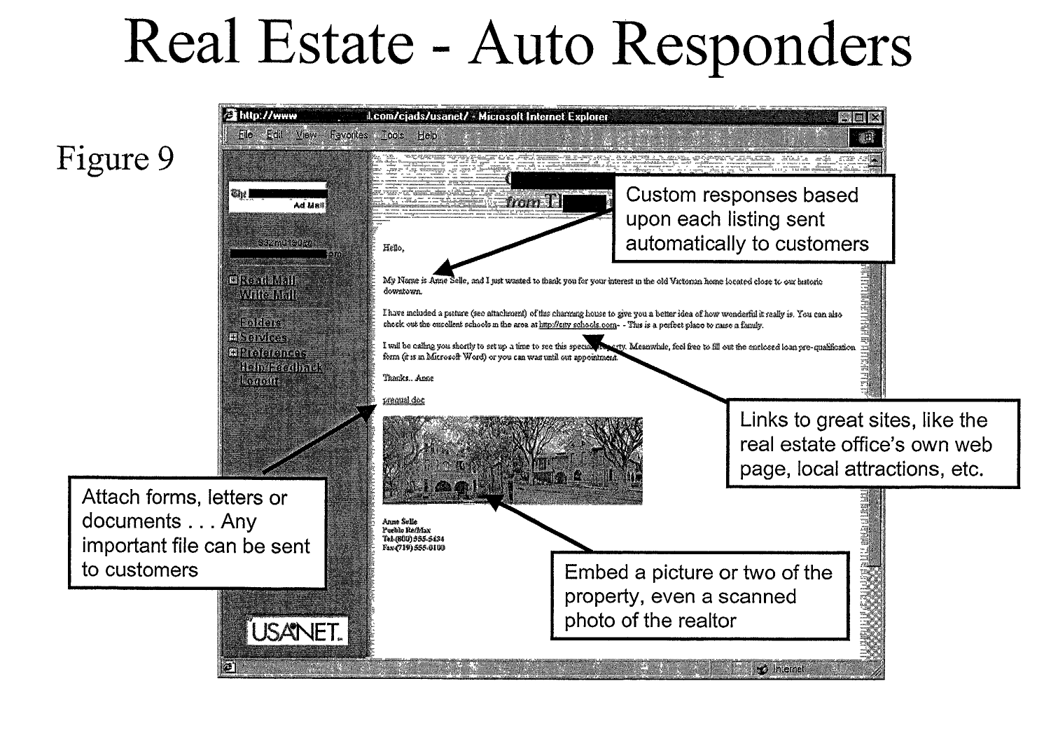

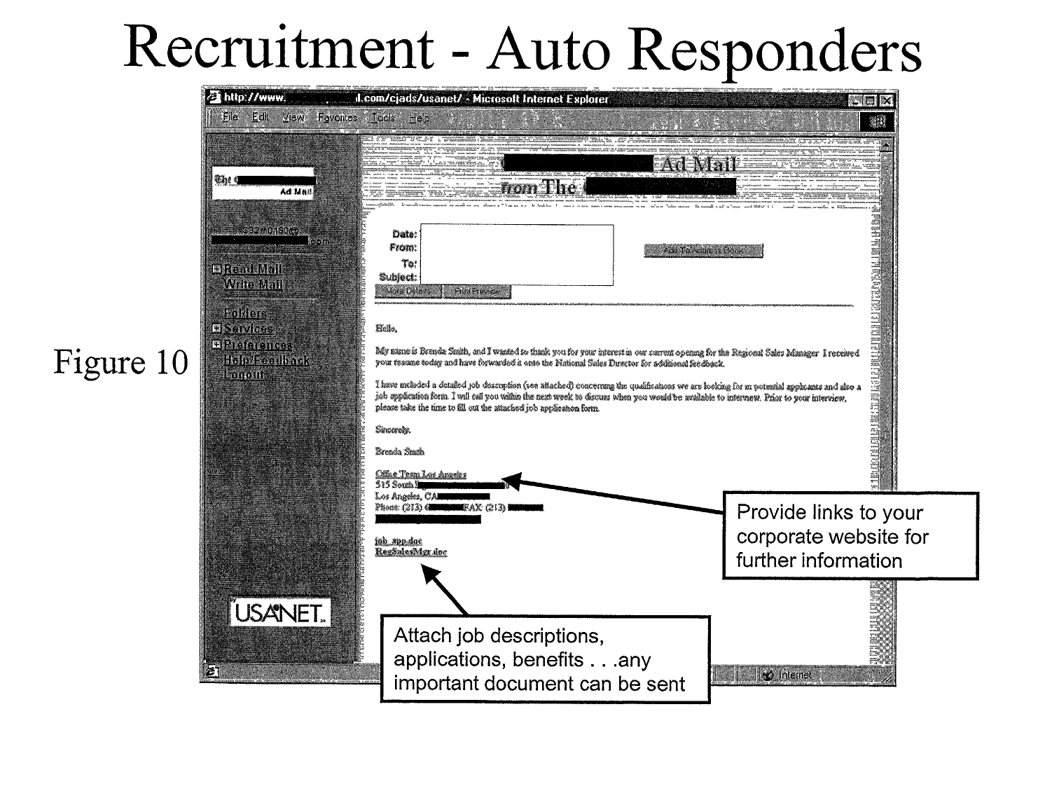

When the seller clicks on the Configure Auto-response hyperlink 508 illustrated in FIG. 5, her browser jumps to the Configure Auto-responder page illustrated in FIG. 8. Here, the seller can compose her auto-response and determine the conditions under which auto-responses should be sent. For example, the seller can determine that the auto-response should always be sent in response to an incoming e-mail by setting the radio button 802. Alternatively, the auto-response can be sent only when certain conditions are met. See 804. These conditions comprise e-mail-filtering functions that are disclosed in U.S. Pat. No. 5,937,161 to Mulligan et al. and expressly incorporated herein by reference, as well as other functions well known in the art. In the message field 806, the seller composes the message to be e-mailed, possibly including hyperlinks, photos and file attachments as explained above and well known in the art. Moreover, the seller can preview what the finished e-mail will look like by clicking on the Preview button 808, and check her spelling by clicking the Check Spelling button 810. In addition to the auto-response example illustrated in FIG. 7, FIGS. 9 and 10 illustrate other possible auto-responses for real estate sales and employment listings, respectively.

Another feature of the present invention is the e-mail forwarding option. The seller can configure her temporary e-mail account to forward automatically all received inquiries to any one of a number of different personal communications devices or accounts. For example, the seller can configure the account to forward inquiries to a personal e-mail address. This saves the seller from having to log on to the newspaper's Web page to read her inquiries. Instead, she can receive them via an e-mail account where she spends more time (for example, at work). Alternatively, the seller can configure inquiries to be sent to her pager, cellular telephone, PDA, or other electronic device capable of receiving text messages. In this way, she will always have nearly-instantaneous access to inquiries about her ad, and she can act upon a serious lead immediately. Finally, the seller could have all inquiries forwarded to her fax machine if, for example, she does not have Web access or a personal e-mail account, or prefers fax over e-mail.

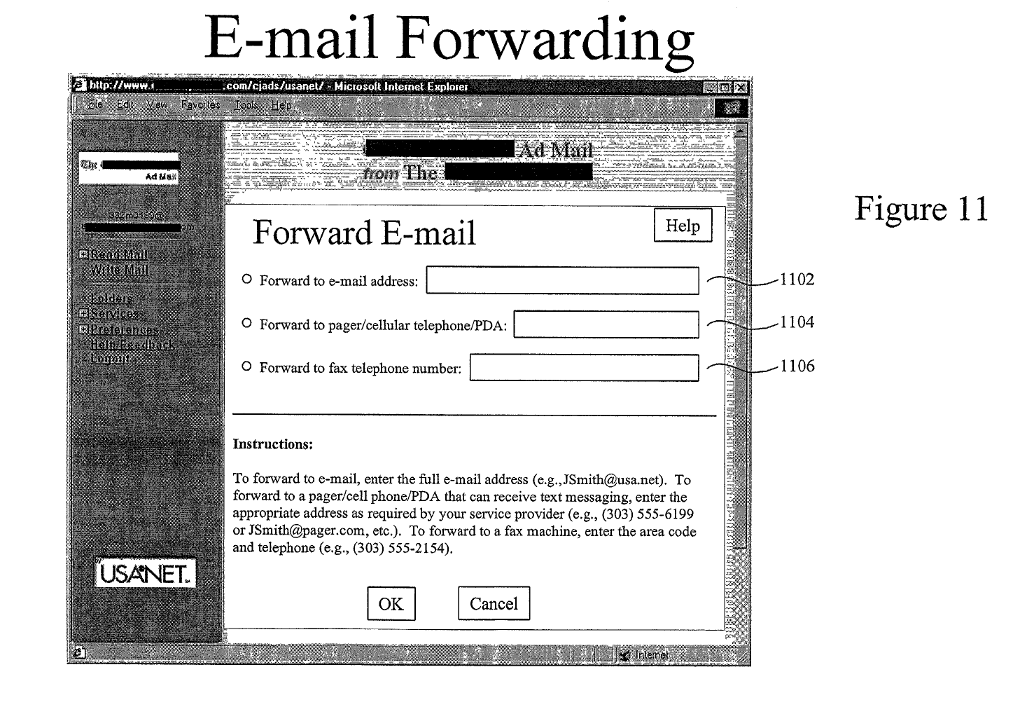

Returning to FIG. 5, the seller can configure the Ad Mail system to forward all received e-mails by clicking on the Forward E-mails hyperlink 510. This hyperlink takes her to the Forward E-mails screen illustrated in FIG. 11. To forward received inquiries to another e-mail account, the seller enters the address of that e-mail account in field 1102; to forward inquiries to her pager/cell phone/PDA address, she enters the appropriate telephone number or other address in field 1104, as appropriate; to forward inquiries to a fax machine, she enters the telephone number of the fax in field 1106. Other forwarding destinations are possible, including telegram, hand delivery, telephone messenger service, etc.; the scope of the invention is not limited by the method of delivery. In the preferred embodiment, the Forward E-mail function also includes e-mail filtering functions as shown in FIG. 8, items 802 and 804, and explained above in connection with FIG. 8 (not shown in FIG. 11). This permits the seller to forward only those e-mails that meet certain requirements.

Other features that can be included in the e-mail accounts are (1) electronic “folders” for filing, classifying and storing received inquiries; (2) auto-signatures; (3) help/feedback features; (4) the ability to block junk e-mail or “spam”; and (5) the ability to log out of the e-mail account. All of these features, including those explained above, are included in the preferred embodiment.

When the Ad Mail system receives e-mail addressed to an account that has activated e-mail forwarding, the system automatically forwards the e-mail to the number/address established by the seller (converting the e-mail to a different format, if necessary). For example, if the seller has set her Ad Mail account to forward inquiries to her personal e-mail address 1102, the Ad Mail system merely forwards the inquiry to that e-mail address. If, instead, the seller has set e-mails to be forwarded to a pager/cell phone/PDA, the system converts the e-mail into a text message (if necessary) and sends it to the appropriate number 1106. Finally, if the seller has set e-mail to be forwarded to fax, the system converts the inquiry into a fax image computer file, calls the fax number entered at 1104 via a fax/modem, and transmits the e-mail as a fax document. Those skilled in the relevant arts will recognize that other embodiments are possible.

The system of the present invention can help enhance the newspaper's bottom line and on-line presence. To begin with, the associated e-mail account is a premium service for which the newspaper may charge a premium, thus increasing revenues. Moreover, since newspapers typically charge classified advertisers by the line or the character, adding an e-mail address to the ad will increase the cost of the ad, again increasing revenues. (Of course, some newspapers may charge a flat rate for the Ad Mail service, or charge no premium at all, in order to make its classified more competitive.) Further, as illustrated in FIGS. 4, 5 and 6 (elements 406, 514 and 600, respectively) the various Ad Mail pages on the newspaper's Web page may contain various advertisements, thus generating additional revenues for the newspaper. And, as more newspaper readers purchase classified ads with an associated e-mail account, more readers will become exposed to the newspaper's Web page.

Operation of the System

Now that the use of the present invention has been explained, the operation of the system of the present invention will be set forth. FIG. 12 illustrates the operation of the present invention. In step 1200, the seller purchases (or renews) a classified ad with an associated temporary e-mail account, and the newspaper collects the necessary information for the ad, as was explained above with respect to steps 100 to 102 of FIG. 1. In step 1202, after the newspaper's deadline expires for receiving classified ads, the newspaper generates a data file containing the necessary information for creating new classified e-mail accounts, and maintaining the appropriate ones of the newspaper's existing accounts. This step corresponds, in part, to step 106 in FIG. 1, and is typically done daily. The creation, contents and formatting of this data file will be explained in detail below, but briefly summarized, this data file contains the information for creating new e-mail accounts, identifies existing accounts to be deleted (based in part on the expiration of the ad), or identifies existing accounts to be renewed (because the ad was renewed).

In step 1204, the newspaper transmits the data file to the e-mail account service provider. Details of this transmission will also be explained in detail below. In step 1206, upon receipt of the data file, the service provider checks the data file for proper formatting. In step 1208, the service provider sends the newspaper an acknowledgment that the data file was received, and indicates whether all entries were complete and formatted correctly. If any entries are incomplete and/or incorrectly formatted, the acknowledgment will identify those entries so that the newspaper may retransmit the correct information quickly. The purpose of this data verification is to ensure that the service provider receives the correct account information in enough time to create the e-mail accounts before their associated classified ads are published and distributed.

In an alternative embodiment, the newspaper itself can operate the e-mail system. In this case, it may be possible to arrange the system so that the data file transmission, acknowledgement, verification and reporting operations may not be necessary.

At step 1210, the verified data is uploaded to the e-mail system, which uses the data to create, delete or renew e-mail accounts as appropriate. The data file is also stored in a secure manner (backed up and redundant) and available for use and manipulation by, for example, finance and billing. In the preferred embodiment, the information for Ad Mail accounts is stored in an Oracle database. At step 1212, the service provider then sends a report to the newspaper verifying the e-mail account activity. In the preferred embodiment, a daily report of account activity is generated that shows the name of the newspaper and at least the e-mail addresses created and the e-mail addresses deleted by the newspaper. Account activity inherently includes at least account creation, but can include account deletion and, as explained below, the number of e-mails received or sent by the account. In the preferred embodiment, a monthly report is also generated that aggregates the monthly usage, showing the name of the newspaper, the e-mail addresses that existed during the month, the date those addresses were created, and the date those addresses were deleted (if applicable). Moreover, in the preferred embodiment, the reports also show the number of messages received daily by each e-mail account.

At some point, step 1214, the service provider invoices the newspaper for its e-mail accounts' activity. There are, of course, numerous ways that this invoicing can be accomplished: daily, weekly, monthly, quarterly, etc. In the preferred embodiment, the monthly account reports are used to generate invoices. In one embodiment, the newspaper is billed a flat rate for each “week” that each account is in existence (a “week” being a 7-day block, or fraction thereof, regardless of what day of the week the account was created). In another embodiment, the newspaper is billed a flat monthly rate for up to 1000 accounts. Activity for several newspapers can also be aggregated in those cases where one company or other entity owns several newspapers that subscribe to the Ad Mail Service. For example, if Acme Co. owns The Daily Sun, The Morning Tribune and The Evening Post, the e-mail account invoices for these three newspapers could be aggregated and sent directly to Acme Co. In other words, the e-mail accounts for these three newspapers can be categorized into one e-mail account group associated with their parent company. This also permits e-mails to be sent to this group's accounts, and to be customized to the group. Of course, the system of the present invention can use other reporting and/or billing methods. The examples given are merely for illustration and/or to show the preferred embodiment at the time the application for the present invention was filed. The examples given are not intended to limit the scope of either the invention or this disclosure.

At some predetermined date before a classified ad expires, the system will automatically generate and e-mail an expiration notice to the associated e-mail account. This is shown in step 1216 of FIG. 12. The expiration notice will typically mention the date the ad will expire, remind the seller to save any inquiries she still needs, and give the seller information about how to renew the ad. Thus, the expiration notice can also serve as a renewal notice. In the preferred embodiment, this is a standard message sent to all accounts. This service will benefit both the seller (by automatically reminding her to renew the ad, if necessary) and the newspaper (by increasing customer satisfaction and generating additional revenue). If an ad is not renewed, it will automatically expire (i.e., will no longer be published) and its associated e-mail account will be deleted. In the preferred embodiment, e-mail accounts are created with a default deletion date 8 days after the ad expires, but the newspaper can include a delete order for a given account in its daily data transmission. The service provider will delete the account on the day following receipt of the delete order.

Setup of New Newspaper Accounts

FIG. 13 illustrates the process of setting up a newspaper account with the e-mail service provider. At step 1300, the newspaper signs the service contract with the service provider. The contract may include such details as the domain name of the newspaper'temporary e-mail accounts (e.g., userid@dailyplanet.com); whether the newspaper or the service provider will host the login page; the volume of e-mail accounts expected; the expected date of the first data feed; pricing; and technical issues such as training and technical support. At step 1302, the service provider's order processing department sets up the newspaper account, including facilitating the registration of the newspaper's domain name, and arranging for proper data exchange with the newspaper. Other setup tasks may include preparing the login pages (if the service provider is hosting the newspaper's Ad Mail pages); arranging for training the newspaper's classified sales staff; establishing billing arrangements, and so forth. There are other well-known operations that can be included in the operation of this service.

When the account is ready for service, the service provider notifies the newspaper that the service provider is ready to receive data, step 1304. The newspaper then transmits a test data file, step 1306, which the service provider verifies for correct transmission, formatting, processing and reporting, step 1308. If all goes properly, the service provider is ready to receive actual account creation orders, step 1310.

Details of Data Exchange Formats

This section describes the formats for the exchange of data between the newspaper and the service provider in order to create, renew and delete classified ad e-mail accounts. To simplify the administrative burden on the newspapers, the newspaper merely extracts the necessary data listed below from its classified ads sales database. This data for creating the e-mail account can be a portion or subset of the information the newspaper received from the seller in order to publish the ad, as seen in Tables 1 and 4 below. For example, the text of the ad may not need to be sent to the e-mail service provider. Nevertheless, the present invention is not limited to sending a portion or subset of the ad information to the service provider; the entire portion of the received information can be sent and still fall within the intended scope of the invention. The particular items of information needed by the service provider will depend on the service provider's implementation, and those items illustrated in this disclosure are not intended to limit the breadth of the invention.

The data may be exchanged with the service provider in either of two formats. In the first embodiment, the data can be formatted into a special text-based e-mail to be sent to the service provider. The body of this e-mail contains data identifying the newspaper's account and listing all actions to occur for that account (for example, to create, delete and renew accounts). The e-mail must be sent to a dedicated e-mail account at the service provider (e.g., admail.feed@serviceprovider.net) from a predefined e-mail address at the newspaper (e.g., admail.feed@newspaper.com) in order to be processed. If the service provider does not recognize the e-mail address from which a message was sent, the message will not be processed. In a second embodiment, the service provider uses an LDAP interface that allows the newspaper to access directly the service provider's master service directory, and create or modify individual e-mail accounts in real-time within a secured environment. Regardless of which method of data transfer that the newspaper uses, the service provider will acknowledge the receipt of the data. Each of these embodiments will be described below, but others are possible.

In the first embodiment, the data for creating, renewing or deleting e-mail accounts is formatted into the message of an e-mail sent to the service provider. The body of that message must contain the following elements, and each instance of an element must be on a new line within the message body:

1) Domain Name. In the preferred embodiment, this comprises the Newspaper's domain name (e.g., dailyplanet.com), which the service provider can assist in obtaining if necessary. Only one instance of this element is allowed per message, and must exist alone as the first non-blank line in the message.

2) Line Format Definition. The Line Format Definition describes the data to be specified in each account request as defined in the Request Data Lines, and the order in which the data will be specified. In the preferred embodiment, this comprises a comma-delimited list of attribute codes. Possible attribute codes are described below in Table 1, but the use of attribute codes not defined in the implementation should result in a message processing failure. Possible action codes are described below in Table 2. Only one instance of the Line Format Definition is allowed per message, and must exist as the next non-blank line in the message after the Domain Name. In the preferred embodiment, the Line Format Definition consists of four fields: actionCode, mail, userAcctExpires, userpassword.

TABLE 1
Possible Attribute Codes and their Descriptions

| Attribute Code | Description |
|---|---|
| actionCode | Required field; must be first. This code |
| | identifies the action to be taken with the |
| | Request Data Line information. The valid |
| | values are: |
| | “a” - ADD new account |
| | “r” - RENEW an existing account |
| | “d” - DELETE an existing account |
| mail | Required field; must be second. This field |
| | contains the new e-mail address (minus |
| | the domain). This field must be between 3 |
| | and 30 alphanumeric characters (a-z; 0-9) |
| | and/or special characters (“.” “-” and “_”), |
| | but the address must begin or end with an |
| | alphanumeric character. |
| UserAcctExpires | Required field for ADD and RENEW |
| | actions; must be third. This field |
| | identifies the date when the user access to |
| | the account will expire. |
| | The format is: YYYY:MM:DD |
| Userpassword | Required field for ADD actions; must be |
| | fourth. This field contains the password |
| | for accessing the account. The password |
| | must be less than 29 alphanumeric characters |
| | in length, and is case sensitive. |
| PasswordHint | This field contains a password hint to help a |
| | user recall a forgotten password. |
| | PasswordHint needs to be text in the form of |
| | a question that indicates how passwords are |
| | being assigned. For example, if the password |
| | is the customer's last name, the |
| | PasswordHint should be “Last name?”; |
| | if the password is the customer's telephone |
| | number, the PasswordHint should be |
| | “Telephone number?”. |
| givenname | First name |
| sn | Last name |
| cn | Common name; the name as it appears on an |
| | out-going e-mail. Normally the first and |
| | last name. |
| postaladdress | Address 1 |
| street | Address 2 |
| 1 | City |
| st | State |
| c | Country |
| postalcode | Zip/postal code |
| homePhone | Home phone |
| workPhone | Work phone |
| facsimileTelephoneNumber | Fax |
| homeURL | Home page URL |
| mobile | Cell phone |
| Pager | Pager number |

TABLE 2
Possible Action Codes and their Descriptions

| Action Code | Description |
|---|---|
| a | ADD an account. Required attributes (per the Line Format |
| | Definition, and the order of attributes is important): |
| | actionCode, mail, UserAcctExpires, Userpassword. |
| | The ADD action may also accept the following additional |
| | optional attributes in any order: givenname, sn, cn, |
| | postaladdress, street, 1, st, c, postalcode, homePhone, |
| | workPhone, facsimileTelephoneNumber, homeURL, |
| | mobile, pager, and/or PasswordHint. If any optional |
| | attributes are specified, all Request Data Lines must |
| | provide empty data elements as placeholders for each. |
| | If an ADD Request Data Line contains numbers of elements |
| | beyond the number of attributes defined in the Line |
| | Format Definition, the entry will fail. |
| r | RENEW an account. Required attributes (per the Line |
| | Format Definition, and the order of attributes is |
| | important): actionCode, mail, UserAcctExpires. |
| | The RENEW action does not allow for any optional |
| | attributes. If a RENEW Request Data Line contains |
| | elements beyond those attributes defined in the Line |
| | Format Definition, the attributes will be ignored and |
| | the entry will be processed as normal. If a RENEW |
| | Request Data Line does not have all the required |
| | attributes defined in the Line Format Definition, |
| | the entry will fail. |
| d | DELETE an account. Required attributes (per the Line |
| | Format Definition, and the order of attributes is |
| | important): actionCode, mail. |
| | The DELETE action does not allow for any optional |
| | attributes. If a DELETE Request Data Line contains |
| | elements beyond those attributes defined in the Line |
| | Format Definition, the attributes will be ignored and |
| | the entry will be processed as normal. If a DELETE |
| | Request Data Line does not have all the required |
| | attributes defined in the Line Format Definition, the |
| | entry will fail. |

3) Request Data Line. In the preferred embodiment, each Request Data Line is a comma-delimited list of data elements that specifies a unique account request. Any number of these Requests may exist in the message, but each must be on a new line. Each line must conform to the Line Format Definition and the action code requirements defined below. Multiple request types (e.g., create, delete or renew) may be specified in the Request Data Lines of the same message.

Several examples of possible data messages are shown in Table 3.

TABLE 3
Examples of Data Messages

| Complete Message Text | Comments |
|---|---|
| morningstar.net | Data from the Morning Star |
| | Classifieds. The login |
| ActionCode, mail, userAcctExpires, | names/mail addresses consist |
| userpassword, PasswordHint | of 8 digit numbers (e.g., |
| a, 15612999, 2000:07:15, 040969, | 15612999@morningstar.net). |
| Your birthday? (mmddyy) | |
| r, 15614155, 2000:07:21 | These are using the optional |
| a, 15614160, 2000:07:21, 071268, | PasswordHint field. |
| Your birthday? (mmddyy) | |
| a, 15615601, 2000:07:15, 121864, | |
| Your birthday? (mmddyy) | |
| d, 15592934 | |
| morningsun.net | Data from the Morning Sun in |
| | the format of the preferred |
| actionCode, mail, userAcctExpires, | embodiment. The login |
| userpassword | names/mail addresses have |
| a, JSmith, 2000:07:10, 090765 | been chosen to be the seller's |
| r, NChristiansen, 2000:07:05 | first initial and last name (e.g., |
| a, ALincoln, 2000:08:21, 121347 | JSmith@morningsun.net). The |
| a, RJones, 121864, 2000:08:15, | passwords are the sellers' birth |
| 402771 | dates. |
| d, GBrown | |

In the preferred embodiment, the newspaper transmits (e-mails) the data file to the service provider each evening after the newspaper's deadline for receiving classified ads, although it does not matter when the data file is sent or received. The service provider then creates the accounts and makes them available for use by 5:00 A.M. the next morning. Typically, however, the accounts are available as soon as the data is processed, verified and uploaded to the e-mail system by the service provider (steps 1206 and 1208 in FIG. 12).

In the second embodiment of the data exchange, the service provider uses an LDAP interface that allows the newspaper to access directly the service provider's master service directory, and create or modify individual e-mail accounts in real-time within a secured environment. The master service directory maintains data in an LDAP hierarchy, which it stores in an Oracle database. All access to the LDAP is secured and authenticated, and any account information modified via LDAP is acknowledged by the service provider (as shown in FIG. 12, step 1208).

LDAP is a standards based directory access protocol. It is a common language that LDAP clients and servers can use to communicate with each other. Unlike other directory protocols like X.500, LDAP is “Lightweight” in that it is relatively simple to implement and only operates over TCP/IP. This makes it easy to build LDAP support into applications and programming languages. It is also straightforward to develop LDAP enabled client programs using various Software Development Kits (SDKs) that are available for C/C++ and Java. This ease of implementation is also leading to LDAP support making it into scripting languages like Perl and PHP. The ability to use the LDAP interface from many popular programming languages provides the flexibility that many customers require in order to develop custom integrated applications. LDAP communications can be optionally encrypted via the Secure Sockets Layer (“SSL”) for enhanced security.

In the preferred embodiment, the service provider uses Netscape's LDAP Server version 3.1. It is configured to listen on a particular port for SSL access by select customers. Although the port can be accessed via command-line utilities provided by Netscape, the service provider's customers will typically need to develop C/C++, Java or Perl programs to access the interface. The examples in the table below are based on the command-line LDAP utilities provided by Netscape (ldapmodify—a, ldapmodify, ldapdelete and ldapsearch). The sample files are in LDAP Data Interchange Format (LDIF). As explained above, the service provider acknowledges the receipt of the data, even if received via the LDAP interface.

TABLE 4
LDAP Interface Definitions and Examples

| | |
|---|---|
| Available User | Add, Modify, Delete, Search (limited) |
| Operations: | |
| Bind Options: | bind as Postmaster |
| PM Bind DN: | uid=<PM_ID>,ou=users,o=<PO_DOMAIN>,o=Post- |
| | offices,o=Postoffice.Net |
| User DN: | uid=<USER_ID>,ou=users,o=<PO_DOMAIN>,o=Post- |
| | offices,o=Postoffice.Net |

User Add Specification:

Required Fields:
dn
objectClass
o
mail
userpassword
classofservice
passwordHint
acctExpires (Ad Mail Domains only)
Optional Fields:
* givenname
* sn
cn
street
postaladdress
l
st
postalcode
c
telephonenumber
homePhone
mobile
pager
facsimileTelephoneNumber
home URL
* Recommended
Example:

ldapmodify -a -D

“uid=<PM_ID>,ou=users,o=<PO_DOMAIN>,o=Postoffices,o=Post-
office.Net”

-w “<PM_PASSWORD>”
-h ldap.postoffice.net -p 636 -Z -P
<path_to_cert7.db_file>
-f INPUT_FILE_NAME

Example input file:
dn: uid=jsmith,ou=users,o=mail.ups.com,o=Postoffices,o=Postoffice.Net
objectClass: inetOrgperson
o: mail.ups.com
mnail:jsmith13ail.ups.com
classOfService: cosXyZakejl
passwordHint: Telephone number?
acctExpires: 1999:12:15
userpassword: broncos
givenname: Julie
sn: Smith
cn: Julie Smith
street: 23 Main Street
l: Cranberry Falls
st: Vermont
postalcode: 09251
c: US

User Modify Specification:

Example:
ldapmodify -D “uid=postmaster,ou=users,o=mail.ford.com,o=Post-
offices,o=Postoffice.Net”

-w “abc123xyz”
-h ldap.postoffice.net -p 636 -Z -P
<path_to_cert7.db_file>
-f INPUT_FILE_NAME

Example input file:
dn: uid=jsmith,ou=users,o=mail.ford.com,o=Postoffices,o=Postoffice.Net
changetype: modify
replace: userpassword
userpassword: zzyzzx
acctExpires: 1999:12:31

Other Details of Possible Embodiments

In many cases, the newspaper will not want to host the Ad Mail login page, and will leave this function up to the service provider. Other newspapers will want to be able to modify and customize its Ad Mail login page (for example, to add and change advertisements), and these newspapers will be given the appropriate privileges to do so. And, as mentioned above, a third group of newspapers will want to host the e-mail system themselves. The system of the present invention can accommodate each of these desires.

In the preferred embodiment, the Ad Mail system is, from an implementation perspective, a subset of USA.NET's Commercial Messaging Services (“CMS”), but with reduced feature set. For example, the address book, directory search, folders, collecting, scheduling, vacation reply, folder storage, password and user profile are features from CMS that could be eliminated from Ad Mail in order to simplify the service for the user. In fact, several of these features have no real utility in the temporary e-mail environment of the present invention.

One embodiment of the present invention permits the newspapers to categorize their temporary e-mail accounts into groups, for example as defined by classified ad types such as Autos-for-Sale accounts, Real Estate accounts, Recruiting accounts, and so forth. This also allows the expiration/renewal notices to be customized for each defined group. For example, the typical real estate classified ad might be published for 14 days while the typical auto ad might be published for only 3 days. Categorizing all real estate ads together and all auto ads together permits, for example, an expiration notice to be sent to a real estate advertiser 4 days before his ad expires (i.e., 10 days after the ad started running) and an expiration notice to be sent to an auto advertiser 1 day before her ad expires (i.e., 2 days after the ad started running). The text and other features can also be customized to the e-mail group.

Also in the preferred embodiment, the users can use on-line help or on-line feedback to obtain customer service support. In addition, the service provider provides a toll-free telephone number for customer service support, and training for the newspapers' classified sales staff.

What is claimed is:

1. A method for improving classified advertising, the method comprising:
receiving from an advertiser information for a classified advertisement;
sending, via an LDAP interface, said received information to an e-mail service provider;
requesting said e-mail service provider to use said sent information to create a temporary e-mail account;
incorporating the address of said e-mail account into the text of said classified advertisement, whereby said e-mail account becomes associated with said classified advertisement; and
publishing said classified advertisement.

2. The method according to claim 1, further comprising:
receiving from said e-mail service provider an acknowledgement that the information sent via the LDAP interface was received.

3. The method according to claim 1, wherein said sent information is a subset of said received information.

4. A method for improving classified advertising, the method comprising:
receiving from an advertiser information for a classified advertisement;
creating a temporary e-mail account associated with said classified advertisement;
incorporating the address of said e-mail account into the text of said classified advertisement; and
publishing said classified advertisement.

5. The method according to claim 4, wherein said temporary e-mail account is created on an e-mail system operated by the publisher.

6. The method according to claim 4, wherein said temporary e-mail account is created by the publisher on an e-mail system operated by a third-party e-mail service provider.

7. The method according to claim 6, wherein said creating step is performed over an LDAP interface.

8. A method for improving classified advertising, the method comprising:
receiving from a plurality of advertisers information for classified advertisements;
initiating creation of a plurality of temporary e-mail accounts, each account being associated with one of said classified advertisements;
incorporating the address of each said e-mail account into the text of its said associated classified advertisement;
publishing said classified advertisements; and
generating a report of the activity of said e-mail accounts.

9. The method according to claim 8, wherein said generating step is performed daily.

10. The method according to claim 8, wherein said generating step produces a report including the number of messages received by each said e-mail account.

11. A method for improving classified advertising, the method comprising:
receiving from a plurality of advertisers information for classified advertisements;
initiating creation of a plurality of temporary e-mail accounts, each account being associated with one of said classified advertisements;
incorporating the address of each said e-mail account into the text of its said associated classified advertisement;
publishing said classified advertisements; and
categorizing said e-mail accounts into e-mail account groups.

12. The method according to claim 11, wherein said categorizing step aggregates all e-mail accounts of publishers owned by a same entity.

13. The method according to claim 11, wherein said categorizing step aggregates all e-mail accounts whose said associated classified advertisements are of a same classified advertisement type.

14. The method according to claim 11, the method further comprising:
generating a report of the activity of said e-mail account groups.

15. The method according to claim 11, the method further comprising:
sending an e-mail to each e-mail account in a particular e-mail account group.

16. The method according to claim 15, wherein the e-mail sent in said sending step is customized for the e-mail account group.

17. The method according to claim 15, wherein the time for executing said sending step is customized for the e-mail account group.

18. The method according to claim 15, wherein the e-mail sent in said sending step is an expiration or renewal notice to be sent N days before a given classified advertisement expires, and N is customized for the e-mail account group.

19. A method for improving classified advertising, the method comprising:
receiving from an advertiser information for a classified advertisement;
initiating creation of a temporary e-mail account, said account being associated with said classified advertisement;
incorporating the address of said e-mail account into the text of said associated classified advertisement;
publishing said classified advertisement; and
initiating the forwarding of e-mails sent to said e-mail account to a predetermined fax machine.

20. A system for improving classified advertising, comprising:
means for receiving from an advertiser information for a classified advertisement;
means for sending, via an LDAP interface, said received information to an e-mail service provider;
means for requesting said e-mail service provider to use said sent information to create a temporary e-mail account;
means for incorporating the address of said e-mail account into the text of said classified advertisement, whereby said e-mail account becomes associated with said classified advertisement; and
means for publishing said classified advertisement.

21. The system according to claim 20, wherein said sent information is a subset of said received information.

22. The system according to claim 20, further comprising:
means for receiving from said e-mail service provider an acknowledgement that the information sent via the LDAP interface was received.

23. A system for improving classified advertising, comprising:
means for receiving from an advertiser information for a classified advertisement;
means for creating a temporary e-mail account associated with said classified advertisement;
means for incorporating the address of said e-mail account into the text of said classified advertisement; and
means for publishing said classified advertisement.

24. The system according to claim 23, wherein said temporary e-mail account is created on an e-mail system operated by the publisher.

25. The system according to claim 23, wherein said temporary e-mail account is created by the publisher on an e-mail system operated by a third-party e-mail service provider.

26. The system according to claim 25, wherein said means for creating operates over an LDAP interface.
